(19) United States
(12) Patent Application Publication
(10) Pub. No.: US 2019/0072781 A1
(43) Pub. Date: Mar. 7, 2019

(54) LENS ANGLE-ADJUSTABLE GLASSES

(71) Applicant: ChaeHyun LIM, Seoul (KR)

(72) Inventor: ChaeHyun LIM, Seoul (KR)

(21) Appl. No.: 16/121,129

(22) Filed: Sep. 4, 2018

(30) Foreign Application Priority Data
Sep. 7, 2017 (KR) 20-2017-0004734

(51) Int. Cl. G02C 5/22

(52) U.S. Cl. CPC G02C 5/2263

(57) ABSTRACT

Disclosed herein are lens angle-adjustable glasses. The lens angle-adjustable glasses include an adjustment grip and angle adjusting and coupling members. The adjustment grip is coupled to the upper end portions of lenses in an integrated manner, and is manually manipulated in order to adjust the angle of the lenses in forward and backward directions. The angle adjusting and coupling members couple the lenses to a glass frame so that the lenses can be rotated in forward and backward directions, and maintain the angle of the lenses in response

### CROSS-REFERENCE TO RELATED APPLICATIONS

This application claims the benefit of Korean Application No. 20-2017-0004734, filed Sep. 7, 2017, in the Korean Intellectual Property Office. All disclosures of the document named above are incorporated herein by reference.

### BACKGROUND

### 1. Technical Field

The present invention relates generally to glasses, and more specifically to lens angle-adjustable glasses that enable a user to freely adjust the angle of lenses while maintaining the location at which a glass frame has been worn in the state in which the user has worn the glasses.

### 2. Description of the Related Art

In general, glasses are worn in order to compensate for visual acuities. Glasses include lenses formed to have lens powers appropriate for visual acuities, and a glass frame assembly configured to enable the glasses to be worn on the face of a user in the state in which the lenses are mounted therein. Furthermore, the glass frame assembly includes a glass frame configured such that lenses are mounted therein, and temples coupled to the glass frame in which the lenses have been mounted and configured to enable the glasses to be worn on the face of the user.

In the glasses, the temples are configured to be hinged to the glass frame and to be folded in inward directions, and thus the volume of the glasses is minimized when the glasses are not worn, thereby providing the convenience of storage and carrying of the glasses. Nose pads are provided on the center portions of the inside of the glass frame, and thus the glass frame in which the lenses have been mounted can be stably supported without sliding down when the glasses are worn.

Conventionally, when a user views an object through lenses while wearing glasses, there are frequent cases where the user lowers or lifts a glass frame to adjust the angle of the lenses in order to more clearly view the object in accordance with a viewing angle. As a result, the glasses are excessively pressed against the nose of the user, and thus a problem arises in that inconvenience is caused to the user.

### SUMMARY

The present invention is proposed to overcome the above-described problem of the prior art, and an object of the present invention is to provide lens angle-adjustable glasses that enable a user to freely adjust the angle of lenses while maintaining the location at which a glass frame has been worn in the state in which the user has worn the glasses.

In order to accomplish the above object, the present invention provides lens angle-adjustable glasses including: an adjustment grip coupled to the upper end portions of lenses in an integrated manner, and configured to be manually manipulated in order to adjust the angle of the lenses in forward and backward directions; and angle adjusting and coupling members configured to couple the lenses to a glass frame so that the lenses can be rotated in forward and backward directions, and also configured to maintain the angle of the lenses in response to the manipulation of the adjustment grip.

Each of the angle adjusting and coupling members may include: a glass frame coupling member configured to be coupled to the glass frame; a lens coupling member configured to be coupled to a corresponding one of the lenses; and a rotational coupling portion configured to rotatably couple the glass frame coupling member and the lens coupling member to each other and to enable the angle of the lenses to be adjusted.

The glass frame coupling member may be formed in a bent shape, and may include a frame coupling and accommodating portion configured to accommodate the glass frame coupled thereto and an opening configured to enable the glass frame to be inserted into the frame coupling and accommodating portion; the lens coupling member may be formed in a bent shape, and may include a lens coupling and accommodating portion configured to accommodate the lens coupled thereto and an opening configured to enable the lens to be inserted into the lens coupling and accommodating portion; and the rotational coupling portion may rotatably couple a contact portion provided on the glass frame coupling member and a contact portion provided on the lens coupling member to each other, thereby enabling the angle to be adjusted, and may maintain the state in which the glass frame coupling member and the lens coupling member have been rotated without change in the state in which the angle of the lens has been adjusted, thereby maintaining the adjusted angle of the lens.

According to the present invention, a user can freely adjust the angle of the lenses while maintaining the location at which the glass frame has been worn in the state in which the user has worn the glasses. Accordingly, when the user adjusts the angle of the lenses in the state of wearing the glasses, it is not necessary to lower or lift the location of the glass frame, and thus the glasses are prevented from being excessively pressed against the nose of the user, thereby improving the convenience of use of the glasses.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating glasses according to the present invention;

FIG. 2 is a side view illustrating the adjustment of the angle of lenses in the glasses according to the present invention;

FIG. 3 is a perspective view illustrating an angle adjusting and coupling member applied to the present invention; and

FIG. 4 is a cross-sectional view illustrating a state in which a rotational coupling portion applied to the present invention has been coupled.

### DETAILED DESCRIPTION

Embodiments of the present invention will be described in detail below with reference to the accompanying drawings. In the following description, when it is determined that a description of a related well-known technology may make the gist of the present invention unnecessarily obscure, the detailed description will be omitted. Furthermore, the numerals used in the description of the present specification are merely identification symbols which are each intended to distinguish one component from another.

Furthermore, the terms used in the present specification and the attached claims should not be interpreted as being limited to the dictionary meanings thereof, but should be interpreted as having meanings and concepts suitable for the technical spirit of the invention based on the principle that an inventor may appropriately define the concepts of terms in order to describe his or her invention in the best way.

Accordingly, the embodiments described in the present specification and the configurations shown in the accompanying drawings correspond merely to examples of the present invention and do not encompass the overall technical spirit of the present invention, with the result that it should be appreciated that there may be various equivalents which can replace the embodiments and the configurations at the time at which the present application is filed.

Embodiments of the present invention will be more specifically described, but technical parts already given will be omitted or abridged for brevity of description.

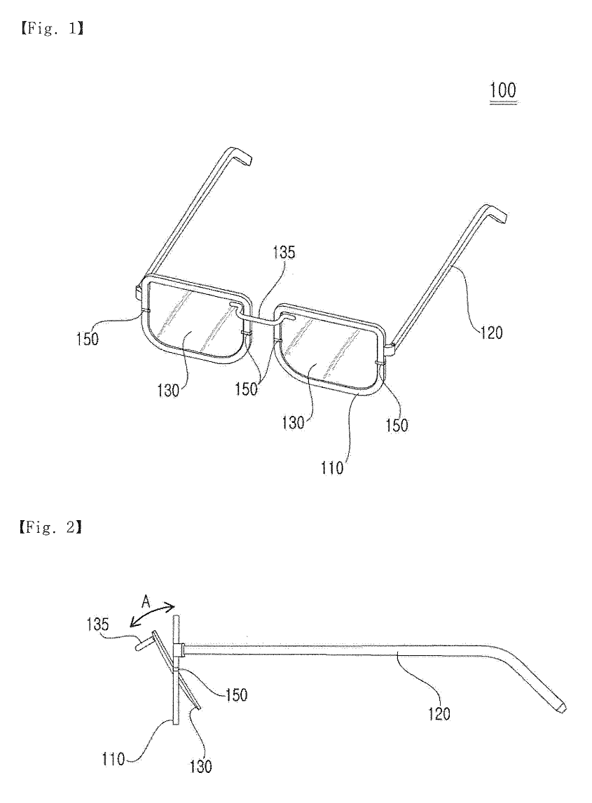

As illustrated in the perspective view of FIG. 1, glasses 100 according to the present invention include: a glass frame 110 configured such that lenses 130 are mounted therein; temples 120 coupled to the glass frame 110 and configured to enable the glass frame 110 to be worn on the ears of a user so that the glasses 100 can be worn on the face of the user; the lenses 130 formed to have lens powers corresponding to the visual acuities of the user, mounted in the glass frame 110, and configured to compensate for the visual acuities of the user; an adjustment grip 135 coupled to the upper end portions of the lenses 130 in an integrated manner, and configured to be manually manipulated in order to adjust the angle of the lenses 130 in forward and backward directions; and angle adjusting and coupling members 150 configured to couple the lenses 130 to the glass frame 110 so that the lenses can be rotated in forward and backward directions, and also configured to maintain the angle of the lenses 130 in response to the manipulation of the adjustment grip 135.

The lenses 130 are mounted in the glass frame 110. More specifically, the lenses 130 are mounted in the glass frame 110 via the angle adjusting and coupling members 150. The angle adjusting and coupling members 150 couple the glass frame 110 and the lenses 130 to one another. More specifically, the angle adjusting and coupling members 150 couple the glass frame 110 and the lenses 130 to one another so that the angle of the lenses 130 can be adjusted. Two angle adjusting and coupling members 150 are allocated to each of the lenses 130, and the lens 130 is coupled to the glass frame 110 via the two angle adjusting and coupling members 150.

The angle adjusting and coupling members 150 enable the user to freely adjust the angle of the lenses 130 in the state in which the lenses 130 have been coupled to the glass frame 110. As illustrated in the side view of FIG. 2, the angle adjusting and coupling members 150 enable the user to adjust the angle of the lenses 130 by manipulating the adjustment grip 135 in the forward or backward direction with his or her hand.

When the user adjusts the angle of the lenses 130 with his or her hand, he or she adjusts the angle of the lenses 130 by operating the adjustment grip 135 forward or backward. When the adjustment grip 135 is operated in a forward or backward direction, the angle of the lenses 130 is adjusted by being inclined in the forward or backward direction based on the angle adjusting and coupling members 150.

The adjustment grip 135 is coupled to the upper portions of the lenses 130 so that it can be integrated with the lenses 130, and protrudes to be bent forward so that the user can operate it with his or her hand. Accordingly, the user may adjust the angle of the lenses 130 by operating the lenses 130 in the forward or backward direction by using the adjustment grip 135.

As indicated by arrow A in FIG. 2, the angle of the lenses 130 may be adjusted in such a manner that the lenses 130 are freely moved by the manual manipulation of the user.

For this purpose, the angle adjusting and coupling members 150 couple the glass frame 110 and the lenses 130 to one another, and are configured to adjust the angle of the lenses 130 in the state of coupling the glass frame 110 and the lenses 130 to one another.

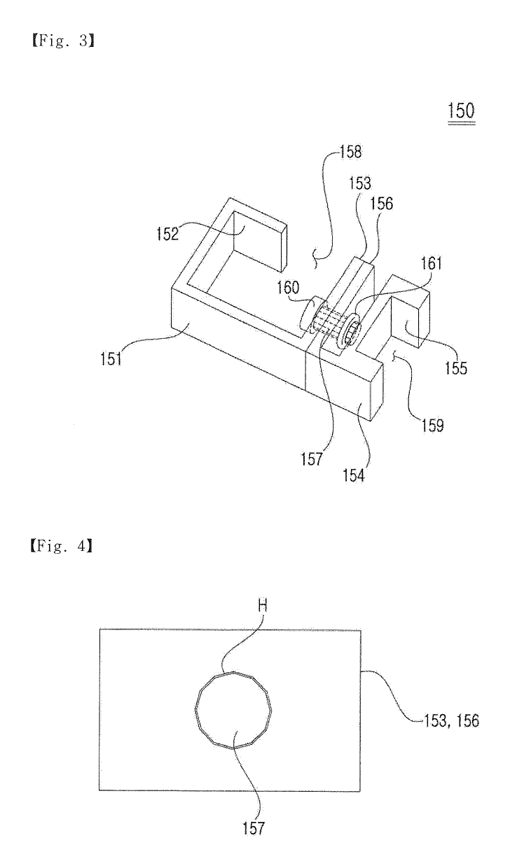

Each of the angle adjusting and coupling members 150 is implemented, as illustrated in FIG. 3. Each of the angle adjusting and coupling members 150 includes: a glass frame coupling member 151 configured to be coupled to the glass frame 110; a lens coupling member 154 configured to be coupled to a corresponding one of the lenses 130; and a rotational coupling portion 157 configured to rotatably couple the glass frame coupling member 151 and the lens coupling member 154 to each other and to enable the angle of the lenses 130 to be adjusted.

The glass frame coupling member 151 is formed in a bent shape, and includes a frame coupling and accommodating portion 152 configured to accommodate the glass frame 110 coupled thereto. The frame coupling and accommodating portion 152 accommodates the coupled portion of the glass frame 110, and the glass frame 110 accommodated in the frame coupling and accommodating portion 152 is coupled to the frame coupling and accommodating portion 152 by a coupling member, such as an adhesive, a coupling pin, or the like.

When the glass frame 110 accommodated in the frame coupling and accommodating portion 152 is coupled by the adhesive, the frame coupling and accommodating portion 152 and the glass frame 110 are coupled to each other by applying the adhesive to the inner wall of the frame coupling and accommodating portion 152 and also applying the adhesive to the portion of the glass frame 110 in contact with the corresponding frame coupling and accommodating portion 152. Alternatively, when the glass frame 110 accommodated in the frame coupling and accommodating portion 152 is coupled by the coupling pin, the frame coupling and accommodating portion 152 and the glass frame 110 are coupled to each other by the coupling pin by forming a hole in the wall of the frame coupling and accommodating portion 152 in contact with the glass frame 110 and also forming a hole in the portion of the glass frame 110 in contact with the corresponding frame coupling and accommodating portion 152 and inserting the coupling pin into the holes of the frame coupling and accommodating portion 152 and the glass frame 110. Alternatively, the glass frame 110 accommodated in the frame coupling and accommodating portion 152 may be coupled using other various methods.

Furthermore, the glass frame coupling member 151 includes an opening 158 configured to enable the glass frame 110 to be easily inserted into the frame coupling and accommodating portion 152. When the glass frame coupling member 151 and the glass frame 110 are coupled to each other, the glass frame 110 may be inserted into the frame coupling and accommodating portion 152 via the opening 158.

The lens coupling member 154 is formed in a bent shape, and includes a lens coupling and accommodating portion 155 configured to accommodate the corresponding lens 130 coupled thereto. The lens coupling and accommodating portion 155 accommodates the coupled portion of the lens 130, and the lens 130 accommodated in the lens coupling and accommodating portion 155 is coupled to the lens coupling and accommodating portion 155 by a coupling member, such as an adhesive, a coupling pin, or the like.

When the lens 130 accommodated in the lens coupling and accommodating portion 155 is coupled by the adhesive, the lens coupling and accommodating portion 155 and the lens 130 are coupled by the adhesive by applying the adhesive to the inner wall of the lens coupling and accommodating portion 155 and also applying the adhesive to the portion of the lens 130 in contact with the corresponding lens coupling and accommodating portion 155. Alternatively, when the lens 130 accommodated in the lens coupling and accommodating portion 155 is coupled by the coupling pin, the lens coupling and accommodating portion 155 and the lens 130 are coupled to each other by the pin by forming a hole in the wall surface of the lens coupling and accommodating portion 155 in contact with the lens 130 and also forming a hole in the portion of the lens 130 in contact with the corresponding lens coupling and accommodating portion 155 and inserting the coupling pin into the holes of the lens coupling and accommodating portion 155 and the lens 130. Alternatively, the lens 130 accommodated in the lens coupling and accommodating portion 155 may be coupled by other various methods.

Furthermore, the lens coupling member 154 includes an opening 159 configured to enable the lens 130 to be easily inserted into the lens coupling and accommodating portion 155. When the lens coupling member 154 and the lens 130 are coupled to each other, the lens 130 may be inserted into the lens coupling and accommodating portion 155 via the opening 159.

Furthermore, the rotational coupling portion 157 rotatably couples a contact portion 153 provided on the glass frame coupling member 151 and a contact portion 156 provided on the lens coupling member 154 to each other, and thus the angle of the lens 130 may be adjusted by rotating the lens 130 in the state in which the glass frame 110 has been coupled by the glass frame coupling member 151 and the lens 130 has been coupled by the lens coupling member 154. Furthermore, in the state in which the angle of the lens 130 has been adjusted, the rotational coupling portion 157 maintains the angle of the lens 130 without change by maintaining the state in which the glass frame coupling member 151 and the lens coupling member 154 have been rotated.

As illustrated in FIG. 4, the rotational coupling portion 157 is inserted and rotatably coupled into a hole H provided in the contact portion 153 of the glass frame coupling member 151 and a hole H provided in the contact portion 156 of the lens coupling member 154. In this case, the outer circumferential surface of the cylindrical body of the rotational coupling portion 157 is formed in a polygonal shape, the inner walls of the holes H are formed in a polygonal shape, and the rotational coupling portion 157 is inserted and rotatably coupled into the holes H. The rotational coupling portion 157 is formed in a cylindrical shape, and includes, at one end thereof, a head 160 integrated with the cylindrical body and configured to come into contact with the surface of the contact portion 153 of the frame coupling member 151 and, at the other end thereof, a ring 161 configured to come into contact with the surface of the contact portion 156 of the lens coupling member 154, to be installed on the outer circumferential surface of the cylindrical body of the rotational coupling portion 157, and to be fastened to the surface of the contact portion 156 and the outer circumferential surface of the rotational coupling portion 157 in an integrated manner. The contact portion 156 of the lens coupling member 154 and the rotational coupling portion 157 are integrated with each other by the ring 161, as described above. Accordingly, when the lens coupling member 154 is rotated to adjust the angle of the lens 130, the rotational coupling portion 157 is also rotated inside the holes H of the contact portions 153 and 156, thereby enabling the angle of the lens 130 to be adjusted.

When the outer circumferential surface of the cylindrical body of the rotational coupling portion 157 is formed in a polygonal shape, the corresponding polygonal shape may be, e.g., a dodecagonal shape, an icosikaitetragonal shape, a triacontakaitetragonal shape, or the like, and the same polygonal shape is formed on the inner walls of the holes H of the contact portions 153 and 156. For example, when a dodecagonal shape is formed on the outer circumferential surface of the cylindrical body of the rotational coupling portion 157, a dodecagonal shape is formed on the inner walls of the holes H of the contact portions 153 and 156. In the case where the outer circumferential surface of the rotational coupling portion 157 and the inner walls of the holes H provided in the contact portions 153 and 156 are formed in the same polygonal shape as described above, when the angle of the lens 130 is adjusted through the manipulation of the adjustment grip 135, the rotational coupling portion 157 is rotated inside the holes H and rotates the lens coupling member 154, thereby enabling the angle of the lens 130 to be adjusted. When the adjustment of the angle of the lens 130 is stopped, the polygonal shape formed on the outer circumferential surface of the rotational coupling portion 157 is engaged with the polygonal shape formed on the inner surfaces of the holes H, thereby enabling the state in which the angle of the lens 130 has been adjusted to be maintained.

In other words, as illustrated in the cross-sectional view of FIG. 4, when the rotational coupling portion 157 is rotated through the adjustment of the angle of the lens 130, the polygonal shape formed on the inner walls of the holes H provided in the contact portion 153 of the glass frame coupling member 151 and the contact portion 156 of the lens coupling member 154 is engaged with the polygonal shape formed on the outer circumferential surface of the body of the rotational coupling portion 157, and thus an angle adjustment state is maintained, thereby enabling the state in which the angle of the lens 130 has been adjusted to be maintained without change.

The angle adjusting and coupling members 150 configured as described above may be direction-adjusted and coupled in accordance with the directions in which the coupling target glass frame and the lenses are disposed, and, thus, may be disposed and used on both sides of each of the lenses 130.

The above-described glasses 100 according to the present invention enable a user to adjust the angle of the lenses 130 through the movement of the adjustment grip 135 in forward and backward directions while maintaining the location at which the glass frame 110 has been worn in the state in which the user has worn the glasses on his or her face. Accordingly, when the user adjusts the angle of the lenses in the state of wearing the glasses, it is not necessary to lower or lift the location of the glass frame, and thus the glasses are prevented from being excessively pressed against the nose of the user, thereby improving the convenience of use of the glasses.

Although the present invention has been specifically described in conjunction with the embodiments, the above-described embodiments are merely examples of the present invention. Accordingly, the present invention should not be construed as being limited only to the embodiments, and the scope of the present invention should be construed as encompassing not only the attached claims but also equivalents to the claims.

What is claimed is:

1. Lens angle-adjustable glasses comprising:
an adjustment grip coupled to upper end portions of lenses in an integrated manner, and configured to be manually manipulated in order to adjust an angle of the lenses in forward and backward directions; and
angle adjusting and coupling members configured to couple the lenses to a glass frame so that the lenses can be rotated in forward and backward directions, and also configured to maintain the angle of the lenses in response to manipulation of the adjustment grip.

2. The lens angle-adjustable glasses of claim 1, wherein each of the angle adjusting and coupling members comprises:
a glass frame coupling member configured to be coupled to the glass frame;
a lens coupling member configured to be coupled to a corresponding one of the lenses; and
a rotational coupling portion configured to rotatably couple the glass frame coupling member and the lens coupling member to each other and to enable the angle of the lenses to be adjusted.

3. The lens angle-adjustable glasses of claim 2, wherein:
the glass frame coupling member is formed in a bent shape, and includes a frame coupling and accommodating portion configured to accommodate the glass frame coupled thereto and an opening configured to enable the glass frame to be inserted into the frame coupling and accommodating portion;
the lens coupling member is formed in a bent shape, and includes a lens coupling and accommodating portion configured to accommodate the lens coupled thereto and an opening configured to enable the lens to be inserted into the lens coupling and accommodating portion; and
the rotational coupling portion rotatably couples a contact portion provided on the glass frame coupling member and a contact portion provided on the lens coupling member to each other, thereby enabling the angle to be adjusted, and maintains a state in which the glass frame coupling member and the lens coupling member have been rotated without change in a state in which the angle of the lens has been adjusted, thereby maintaining the adjusted angle of the lens.
